(19) United States
(12) Patent Application Publication
(10) Pub. No.: US 2022/0285731 A1
(43) Pub. Date: Sep. 8, 2022

(54) ELECTROLYTE SOLUTION FOR LITHIUM SECONDARY BATTERIES AND LITHIUM SECONDARY BATTERY INCLUDING THE SAME

(71) Applicants: Hyundai Motor Company, Seoul (KR); Kia Corporation, Seoul (KR); UNIST (Ulsan National Institute of Science and Technology), Ulsan (KR)

(72) Inventors: Sang Hun Lee, Paju (KR); Jun Ki Rhee, Suwon (KR); Yeol Mae Yeo, Hwaseong (KR); Seung Min Oh, Incheon (KR); Yoon Sung Lee, Suwon (KR); Ji Eun Lee, Hwaseong (KR); Ko Eun Kim, Cheongju (KR); Woo Young Jin, Busan (KR); Sang Mok Park, Gwangju (KR); Sung Ho Ban, Hwaseong (KR); Hyeon Gyu Moon, Ulsan (KR); Hui Beom Nam, Daegu (KR); Hyun Soo Ma, Gimcheon (KR); Nam Soon Choi, Ulsan (KR)

(21) Appl. No.: 17/468,222

(22) Filed: Sep. 7, 2021

(30) Foreign Application Priority Data
Mar. 8, 2021 (KR) 10-2021-0030100

(51) Int. Cl. H01M 10/0567; H01M 10/0525; H01M 10/0568; H01M 10/0569; H01M 4/583; H01M 4/38; H01M 4/525; H01M 4/505

(52) U.S. Cl. CPC H01M 10/0567; H01M 10/0525; H01M 10/0568; H01M 10/0569; H01M 4/583; H01M 4/386; H01M 4/525; H01M 4/505; H01M 2250/20; H01M 2300/0042

(57) ABSTRACT

Disclosed is an additive for increasing the electrochemical properties of lithium secondary batteries.

### CROSS-REFERENCE TO RELATED APPLICATION

This application claims the priority benefit of Korean Patent Application No. 10-2021-0030100, filed on Mar. 8, 2021 in the Korean Intellectual Property Office, the disclosure of which is incorporated herein by reference.

### TECHNICAL FIELD

The present invention relates to an electrolyte solution constituting lithium secondary batteries and a lithium secondary battery including the same. The electrolyte solution particularly includes an additive that may improve the electrochemical properties of lithium secondary batteries.

### BACKGROUND OF THE INVENTION

A battery is an energy storage source that can convert chemical energy into electrical energy or electrical energy into chemical energy. A battery may be divided into non-reusable primary batteries and reusable secondary batteries. Secondary batteries are reusable and thus have the advantage of being eco-friendly compared to primary batteries, which are used once and then discarded.

As environmental issues have emerged recently, demand for hybrid electric vehicles (HEVs) and electric vehicles (EVs), causing little or no air pollution, has been increasing. In particular, EVs, which are vehicles including no internal combustion engine, indicate the direction the world is likely to take in the future.

In order for EVs to be commercialized, the problems associated with batteries mounted in EVs should be solved. Batteries installed in EVs must be capable of providing 500 km or greater of driving range using a single charge, of providing output above a certain level to use a high-performance motor, and of being charged at high speed.

Accordingly, lithium-ion batteries having a high theoretical capacity and an electromotive force of 4V or greater and being charged and discharged at a high speed may be suitable for the EV.

A lithium secondary battery typically includes a positive electrode, a negative electrode, an electrolyte, and a separator. At the positive and negative electrodes, lithium ions are repeatedly intercalated and deintercalated to generate energy, the electrolyte acts as a passage enabling lithium ions to travel, and the separator functions to prevent the occurrence of a short circuit in the battery upon contact between the positive and negative electrodes. In particular, the positive electrode is closely related to the capacity of the battery, and the negative electrode is closely related to the performance of the battery, such as high-speed charging and discharging.

The electrolyte includes a solvent, an additive and a lithium salt. The solvent acts as a passage enabling lithium ions to move between the positive and negative electrodes. In order for a battery to have excellent performance, lithium ions should be rapidly moved between the positive electrode and the negative electrode. Therefore, it is a very important issue to select an optimal electrolyte in order to obtain excellent battery performance.

In particular, a thin film called “SEI (solid electrolyte interphase)” is formed on the negative electrode in the formation process performed during the production of the battery. SEI is a film that allows lithium ions to pass through, but does not allow electrons to pass through, and thus prevents deterioration of battery performance due to incidental reactions induced by electrons passing through the SEI. In addition, SEI suppresses direct reactions between the electrolyte and the negative electrode and detachment of the negative electrode.

The electrolyte additive is added in a trace amount of 0.1 to 10% based on the weight of the electrolyte. In spite of being added in a trace amount, the additive greatly affects the performance and stability of the battery. In particular, the additive functions to induce the formation of the SEI on the negative electrode surface and control the thickness of the SEI. In addition, the additive can prevent the battery from being overcharged and can increase the conductivity of lithium ions in the electrolyte.

In addition, silicon (Si) is attracting attention as a negative-electrode active material due to the high theoretical capacity thereof, but the silicon-based negative-electrode active material repeatedly contracts and expands upon repeated intercalation and deintercalation of lithium, and thus the structure thereof becomes unstable and the negative-electrode active material reacts with lithium, causing various problems such as an increase in irreversible capacity, making it difficult to commercialize the negative-electrode active material. Thus, the development of an additive suitable for a silicon-based negative-electrode active material has been a major task.

For these reasons, research and development on additives contained in electrolytes have been actively conducted in the art.

The above information disclosed in this Background section is provided only for better understanding of the background of the present invention, and therefore it may contain information that does not form the prior art that is already known to a person with ordinary skill in the art.

### SUMMARY OF THE INVENTION

In preferred aspect, provided is an additive for an electrolyte solution that can improve the electrochemical properties of a lithium secondary battery when added to an electrolyte solution of the lithium secondary battery.

In an aspect, provided is an electrolyte solution for a lithium secondary battery containing an electrolyte salt, an organic solvent, and a compound represented by the following Formula 1 as an additive.

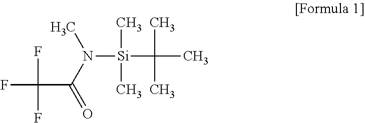

The electrolyte solution may suitably include the compound represented by Formula 1 in an amount of about 0.3 wt % to 1.2 wt % based on the total weight of the electrolyte solution.

The electrolyte solution may suitably include compound represented by Formula 1 in an amount of about 0.3 wt % to 1.0 wt % based on the total weight of the electrolyte solution.

The electrolyte salt may suitably include one or more selected from the group consisting of LiPF₆, LiBF₄, LiClO₄, LiCl, LiBr, LiI, LiB₁₀Cl₁₀, LiCF₃SO₃, LiCF₃CO₂, Li(CF₃SO₂)₃C, LiAsF₆, LiSbF₆, LiAlCl₄, LiCH₃SO₃, LiCF₃SO₃, LiN(SO₂C₂F₅)₂, Li(CF₃SO₂)₂N, LiC₄F₉SO₃, LiB(C₆H₅)₄, and Li(SO₂F)₂N (LiFSI).

A concertation of the electrolyte salt may about 0.5M to 1.0M.

The organic solvent may include one or more from the group consisting of a carbonate-based solvent, an ester-based solvent, an ether-based solvent, and a ketone-based solvent.

In an aspect, provided is a lithium secondary battery including a positive electrode, a negative electrode, a separator interposed between the positive electrode and the negative electrode, and the electrolyte solution as described herein.

The positive electrode may include a positive-electrode active material including Ni, Co, and Mn, and the negative electrode may include at least one of a carbon (C)-based negative-electrode active material or a silicon (Si)-based negative-electrode active material.

Further provided are vehicles that comprise 1) electrolyte solution for a lithium secondary battery as disclosed herein. Also provided are vehicles that comprise a lithium secondary battery as disclosed herein, The vehicles may be electric-powered vehicles.

Other aspect of the invention are disclosed infra.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a graph showing the result of a charge/discharge efficiency test with the exemplary lithium secondary battery according to various exemplary embodiments of the present invention and comparative example;

FIG. 2 is a graph showing the result of a high-temperature lifetime test with the exemplary lithium secondary battery according to various exemplary embodiments of the present invention and comparative example; and

FIG. 3 is a graph showing the discharge capacity of the exemplary lithium secondary battery according to various exemplary embodiments of the present invention and comparative example at 1.0 C, 2.0 C, and 3.0 C.

### DETAILED DESCRIPTION

Reference will now be made in detail to preferred embodiments of the present invention, examples of which are illustrated in the accompanying drawings. However, the present invention is not limited to the embodiments, and may be implemented in various forms. The embodiments are provided only to fully illustrate the present invention and to completely inform those having ordinary knowledge in the art of the scope of the present invention.

As described above, objects, other objects, features, and advantages according to the present invention will be readily understood through the following preferred embodiments associated with the accompanying drawings. However, the present invention is not limited to the embodiments described herein and may also be embodied in other forms. Rather, the embodiments introduced herein are provided so that the invention may be made thorough and complete, and the spirit according to the present invention may be sufficiently conveyed to those skilled in the art.

In this specification, it should be understood that terms such as “comprise” or “have” are intended to indicate that there is a feature, a number, a step, an operation, a component, a part, or a combination thereof described on the specification, and do not exclude the possibility of the presence or the addition of one or more other features, numbers, steps, operations, components, parts, or combinations thereof. Further, when a portion such as a layer, a film, a region, or a plate is referred to as being “above” the other portion, it may be not only “right above” the other portion, or but also there may be another portion in the middle. On the contrary, when a portion such as a layer, a film, a region, or a plate is referred to as being “under” the other portion, it may be not only “right under” the other portion, or but also there may be another portion in the middle.

Unless otherwise indicated, all numbers, values, and/or expressions referring to quantities of ingredients, reaction conditions, polymer compositions, and formulations used herein are to be understood as modified in all instances by the term “about” as such numbers are inherently approximations that are reflective of, among other things, the various uncertainties of measurement encountered in obtaining such values.

Further, unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Further, where a numerical range is disclosed herein, such range is continuous, and includes unless otherwise indicated, every value from the minimum value to and including the maximum value of such range. Still further, where such a range refers to integers, unless otherwise indicated, every integer from the minimum value to and including the maximum value is included.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

Lithium secondary batteries generate heat during discharge, and thus the temperature thereof increases as they are used. The optimal temperature for lithium secondary batteries falls within the range of 15° C. to 40° C. When such a battery is used at a temperature outside this range, the performance of the battery decreases.

Specifically, when the battery is used at a low temperature, the activity of chemical substances decreases and the internal resistance of the battery increases, causing a sharp drop in voltage as well as in discharge capacity. When the battery is used at a high temperature, the activity of chemical substances increases, whereby discharge greater than 100% occurs. As a result, additional chemical reactions occur, deteriorating the performance of the battery.

In particular, in Korea, having four seasons and thus wide temperature fluctuations, an EV can operate normally without causing problems only when a battery capable of exhibiting stable performance even at −40° C. to 60° C. is provided.

Thus, the battery is tested under harsh conditions. In particular, high-temperature lifetime characteristics, meaning the ability to maintain the lifetime without deterioration even when the battery is used at high temperatures, is an important testing consideration.

In addition, since HEVs and EVs require relatively high output compared to smartphones and laptops, discharge capacity at a C-rate of 1 C or greater is another important testing consideration.

Meanwhile, many complicated chemical reactions occur inside the lithium secondary battery. Among these chemical reactions, the electrochemical properties of the battery can be maintained only when reactions that deteriorate the battery are suppressed as far as possible. A particularly important factor is HF that is produced through the reaction of LiPF₆ as a lithium salt with a trace amount of water in the electrolyte solution. HF may destroy the SEI formed on the negative electrode in the initial formation step and react with the active material in the positive electrode to elute the metal ions of the active material.

Therefore, an HF scavenger to remove HF that may be generated in the electrolyte solution is required for the lithium secondary battery.

In one aspect, the present invention provides an electrolyte solution for a lithium secondary battery containing an electrolyte salt, an organic solvent, and the electrolyte solution further contains a compound represented by the following Formula 1 as an additive.

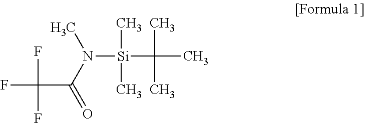

The compound is N-(tert-butyldimethylsilyl)-N-methyltrifluoroacetamide.

The material can remove HF through reaction with HF in the lithium secondary battery.

Particularly, N-(tert-butyldimethylsilyl)-N-methyltrifluoroacetamide may react with HF to produce the following compound.

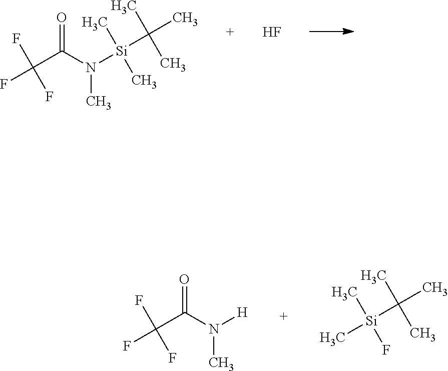

For example, N-(tert-butyldimethylsilyl)-N-methyltrifluoroacetamide may perform the HF-scavenging function through the reaction described above.

Hereinafter, the production of a lithium secondary battery using the additive and the result of an experiment to determine electrochemical properties thereof will be described.

Lithium Secondary Battery

The lithium secondary battery includes a positive electrode, a negative electrode, a separator interposed between the positive electrode and the negative electrode, and an electrolyte solution.

The positive electrode includes an NCM-based positive-electrode active material containing Ni, Co, and Mn, and in particular, the NCM-based positive-electrode active material used herein was NCM811. The positive-electrode active material may be LiCoO₂, LiMnO₂, LiNiO₂, LiNi₁₋ₓCoₓO₂, LiNi_{0.5}Mn_{0.5}O₂, LiMn₂₋ₓMₓO₄ (M is Al, Li or a transition metal), LiFePO, or the like, but any of other positive electrodes that can be used in lithium secondary batteries may be used.

The positive electrode may further include a conductive material and a binder.

The conductive material imparts conductivity to the electrode, and any material can be used, as long as it does not cause chemical changes in the battery and is an electron-conductive material. Examples of the conductive material that can be used in the present invention include natural graphite, artificial graphite, carbon black, acetylene black, Ketjen black, carbon fiber, metal powder such as copper, nickel, aluminum or silver powder, metal fiber, and the like, and at least one conductive material such as a polyphenylene derivative.

The binder serves to promote adhesion between particles of each active material or adhesion thereof to the current collector in order to mechanically stabilize the electrode. That is, the active material is stably fixed in the process of repetitive intercalation and deintercalation of lithium ions to prevent loosening of the bond between the active material and the conductive material. The binder may include polyvinyl alcohol, carboxymethyl cellulose, hydroxypropyl cellulose, diacetyl cellulose, polyvinyl chloride, carboxylated polyvinyl chloride, polyvinyl fluoride, a polymer containing ethylene oxide, polyvinylpyrrolidone, polyurethane, polytetrafluoroethylene, polyvinylidene fluoride, polyethylene, polypropylene, a styrene butadiene rubber, an acrylated styrene butadiene rubber, an epoxy resin, nylon, or the like, but the present invention is not limited thereto.

The negative electrode may include at least one of carbon (C)-based negative-electrode active material or silicon (Si)-based negative-electrode active material, and the carbon-based negative-electrode active material may include at least one selected from the group consisting of artificial graphite, natural graphite, graphitized carbon fiber, graphitized mesocarbon microbeads, fullerene, and amorphous carbon, and the silicon carbon composite material may be SiOₓ or a silicon-carbon complex. In particular, in this embodiment, a mixture of graphite and a silicon-based negative-electrode active material was used.

Like the positive electrode, the negative electrode may further include a binder and a conductive material.

The electrolyte solution includes an organic solvent and an additive.

The organic solvent may be one or more selected from the group consisting of a carbonate-based solvent, an ester-based solvent, an ether-based solvent, and a ketone-based solvent.

The carbonate-based solvent used herein may suitably include dimethyl carbonate (DMC), diethyl carbonate (DEC), dipropyl carbonate (DPC), methyl propyl carbonate (MPC), ethyl propyl carbonate (EPC), ethyl methyl carbonate (EMC), ethylene carbonate (EC), propylene carbonate (PC), butylene carbonate (BC), fluoroethylene carbonate (FEC), vinylene carbonate (VC), or the like. In addition, the ester-based solvent may be y-butyrolactone (GBL), n-methyl acetate, n-ethyl acetate, n-propyl acetate or the like, and the ether-based solvent may be dibutyl ether, but the present invention is not limited thereto.

The solvent may further include an aromatic hydrocarbon-based organic solvent. Specific examples of the aromatic hydrocarbon-based organic solvent include benzene, fluorobenzene, bromobenzene, chlorobenzene, cyclohexylbenzene, isopropylbenzene, n-butylbenzene, octylbenzene, toluene, xylene, mesitylene, and the like, and the aromatic hydrocarbon-based organic solvent may be used alone or in combination.

The separator prevents a short circuit between the positive electrode and the negative electrode, and provides a passage for lithium ions. Such a separator may be selected from well-known separators including polyolefin-based polymer membranes such as polypropylene, polyethylene, polyethylene/polypropylene, polyethylene/polypropylene/polyethylene and polypropylene/polyethylene/polypropylene, and multiple membranes, microporous films, woven fabrics and nonwoven fabrics thereof. In addition, a porous polyolefin film coated with a resin having excellent stability may be used.

Preparation of Batteries According to Comparative Examples and Examples

Production of Positive Electrode

In order to prepare a positive electrode, PVdF was dissolved in NMP to prepare a binder solution.

The binder solution was mixed with Ketjen black as a conductive material and a positive-electrode active material to prepare a slurry, and the slurry was applied to two surfaces of a piece of aluminum foil, followed by drying.

Then, the result was subjected to rolling and drying, and an aluminum electrode was ultrasonically welded thereto to produce a positive electrode. In the rolling process, the thickness was adjusted to be 120 to 150 μm.

The positive-electrode active material used herein was Li₁₊ₓ[Ni_{0.8}Co_{0.1}Mn_{0.1}]O₂ (−0.5<x<0), which is a material containing Ni, Co and Mn at a composition ratio of 8:1:1.

Production of Negative Electrode

In order to prepare a negative electrode, the prepared binder solution was mixed with a negative-electrode active material to prepare a slurry, and the slurry was applied to two surfaces of a piece of aluminum foil, followed by drying.

Then, the result was subjected to rolling and drying, and a nickel electrode was ultrasonically welded thereto to produce a negative electrode. In the rolling process, the thickness was adjusted to be 120 to 150 μm.

The negative-electrode active material used herein was a mixture of graphite (95 wt %) and Si (5 wt %), and was prepared by dry-mixing graphite and SiOx as powders.

Preparation of Electrolyte Solution As an organic solvent, a mixture of EC (ethylene carbonate), EMC (ethyl methyl carbonate), and DEC (diethyl carbonate) at a volume ratio of 25:45:30 was used, and 0.5M LiPF₆ and 0.5M LiFSI as lithium salts were dissolved in the solvent to prepare an electrolyte. In addition, in each example, trimethylsilyl trifluoromethanesulfonate as an additive was added at a different ratio to the organic solvent.

Production of Coin Cell

The separator was interposed between the positive electrode and the negative electrode and rolled to produce a jelly roll. A coin cell was produced using the prepared jelly roll and the electrolyte solution.

### COMPARATIVE EXAMPLE 1

A battery in which no additive was added to the electrolyte solution was used.

### EXAMPLE 1

A battery in which an additive was added in an amount of 0.2 wt % based on the total weight of the electrolyte solution was used.

### EXAMPLE 2

A battery in which an additive was added in an amount of 0.3 wt % based on the total weight of the electrolyte solution was used.

### EXAMPLE 3

A battery in which an additive was added in an amount of 0.5 wt % based on the total weight of the electrolyte solution was used.

### EXAMPLE 4

A battery in which an additive was added in an amount of 1.0 wt % based on the total weight of the electrolyte was used.

### EXAMPLE 5

A battery in which an additive was added in an amount of 1.2 wt % based on the total weight of the electrolyte was used.

Evaluation of Charge/Discharge Efficiency Using Produced Battery

A test was conducted to evaluate the initial charge capacity and discharge capacity of the batteries produced according to Comparative Examples and Examples. The initial charge/discharge efficiency that was used for evaluation was the charge/discharge efficiency that was obtained first after the production of the battery was completed. Evaluation of the initial charge/discharge efficiency is an important factor in evaluating the electrochemical performance of the battery because SEI is formed in the initial charging stage, and is maintained until the battery lifetime is exhausted. At this time, the initial charge/discharge efficiency was measured at a discharge-end voltage of 2.5V, a charge-end voltage of 4.2V, and at a C-rate of 1.0 C. The test was performed at a temperature of 45° C.

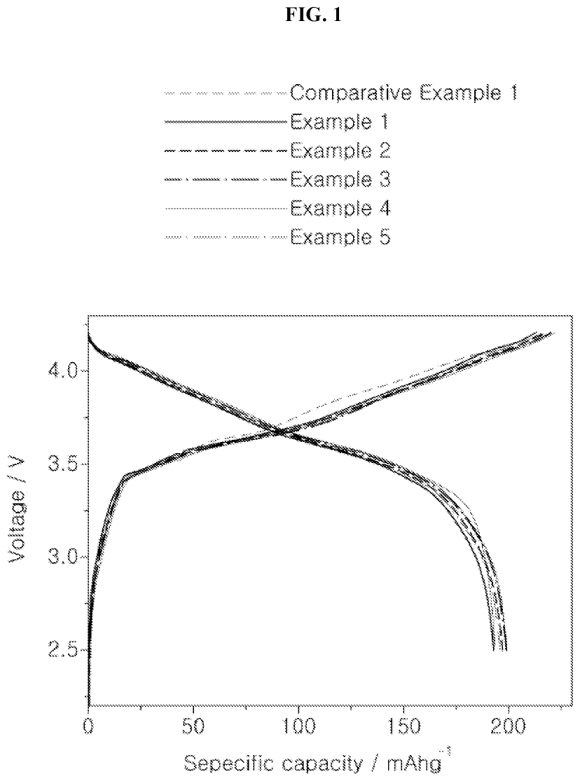

The results of the test are shown in Table 1 below, and a graph thereof is shown in FIG. 1.

TABLE 1

| | | Initial | Initial | Initial |
|---|---|---|---|---|
| | | charge | discharge | charge/discharge |
| | | capacity | capacity | efficiency |
| | Additive | (mAh/g) | (mAh/g) | (%) |
| Comparative | — | 216 | 194 | 89.8 |
| Example 1 | | | | |
| Example 1 | 0.2 | 215 | 193 | 89.7 |
| Example 2 | 0.3 | 220 | 197 | 89.5 |
| Example 3 | 0.5 | 221 | 199 | 90.0 |
| Example 4 | 1.0 | 223 | 199 | 89.3 |
| Example 5 | 1.2 | 218 | 196 | 89.9 |

The results of the test showed that when the content of the additive was 0.5%, the best initial charge/discharge efficiency was obtained, and that Examples exhibited initial charge/discharge efficiency slightly lower or slightly higher than Comparative Examples.

Evaluation of Initial Cell Resistance and High-Temperature Lifetime Using Produced Batteries

A test was conducted to evaluate the initial cell resistance and high-temperature lifetime of the batteries produced according to Comparative Examples and Examples. The initial cell resistance and high-temperature lifetime were measured at a discharge-end voltage of 2.5V, a charge-end voltage of 4.2V, and a C-rate of 1.0 C. The test was performed at a temperature of 45° C. The high-temperature lifetime up to 100 cycles was measured.

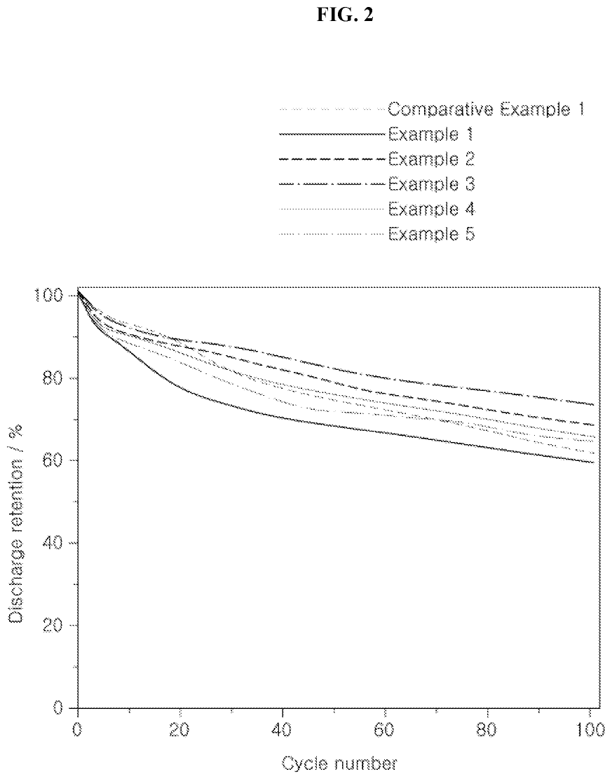

The results of the test are shown in Table 2 below, and a graph thereof is shown in FIG. 2.

TABLE 2

| | | Initial cell | High-temperature |
|---|---|---|---|
| | | resistance | lifetime |
| | Additive | (%) | (%) |
| Comparative | — | 100 | 61.8 |
| Example 1 | | | |
| Example 1 | 0.2 | 99 | 59.7 |
| Example 2 | 0.3 | 98 | 68.8 |
| Example 3 | 0.5 | 96 | 73.9 |
| Example 4 | 1.0 | 101 | 65.6 |
| Example 5 | 1.2 | 99 | 64.7 |

The results of the test showed that upon repetition of 100 cycles of charging and discharging, Example 3, containing 0.5% of the additive, exhibited the best high-temperature lifetime and the lowest initial cell resistance. Example 1 exhibited high-temperature lifetime characteristics inferior to those of Comparative Example 1, to which no additive was added.

Evaluation of High-Rate Characteristics Using Produced Batteries

A test was conducted to evaluate the high-rate discharge capacity of the batteries produced according to Comparative Examples and Examples. The test was performed at a discharge-end voltage of 2.5V, a charge-end voltage of 4.2V, and different C-rates of 1.0 C, 2.0 C and 3.0 C. The test was performed at a temperature of 45° C. The discharge capacity up to 10 cycles was measured.

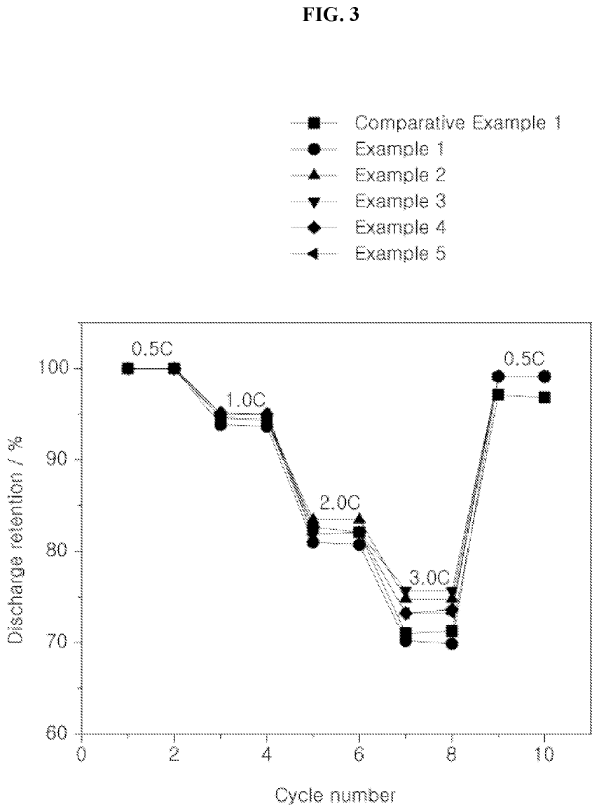

The results of the test are shown in Table 3 below, and a graph thereof is shown in FIG. 3.

TABLE 3

| | | 1.0 C | 2.0 C | 3.0 C |
|---|---|---|---|---|
| | | (discharge | (discharge | (discharge |
| | Additive | capacity %) | capacity %) | capacity %) |
| Comparative | — | 94.4 | 82.5 | 71.3 |
| Example 1 | | | | |
| Example 1 | 0.2 | 93.7 | 81.1 | 70.3 |
| Example 2 | 0.3 | 94.5 | 83.4 | 74.8 |
| Example 3 | 0.5 | 94.5 | 81.7 | 75.6 |
| Example 4 | 1.0 | 95.1 | 82.0 | 73.5 |
| Example 5 | 1.2 | 94.8 | 81.8 | 73.2 |

The results of the test showed that Example 4 exhibited the best discharge capacity at 1.0 C, Example 2 exhibited the best discharge capacity at 2.0 C, and Example 3 exhibited the best discharge capacity at 3.0 C, and that discharge capacity at 2.0 C of most Examples was poorer than that of Comparative Example 1, whereas discharge capacity at 3.0 C of all Examples, excluding Example 1, was better than those of Comparative Example 1.

As can be seen from the test results, when the content ratio of the additive is 0.3 to 1.2 wt % based on the weight of the electrolyte solution, better high-temperature lifetime characteristics than Comparative Examples were obtained, and that when the content ratio of the additive was 0.3 to 1.2 wt % based on the weight of the electrolyte, greater high-rate characteristics at 1.0 C and 3.0 C were obtained compared to Comparative Examples.

As such, the electrochemical properties of the lithium secondary battery can be improved due to the HF-scavenging effect of N-(tert-butyldimethylsilyl)-N-methyltrifluoroacetamide used as an additive.

As apparent from the foregoing, the lithium secondary battery containing the additive of the present invention can prevent HF from destroying the SEI owing to N-(tert-butyldimethylsilyl)-N-methyltrifluoroacetamide contained in the electrolyte solution, and thus has excellent electrochemical performance. In particular, the lithium secondary battery has excellent lifespan characteristics and excellent high-temperature lifetime and lifetime at high C-rates.

Although the present invention has been described with reference to the attached drawings and the various exemplary embodiments, those skilled in the art will appreciate that various modifications, additions and substitutions are possible, without departing from the scope and spirit of the invention as disclosed in the accompanying claims.

What is claimed is:

1. An electrolyte solution for a lithium secondary battery comprising:
an electrolyte salt;
an organic solvent; and
a compound represented by the following Formula 1 as an additive.

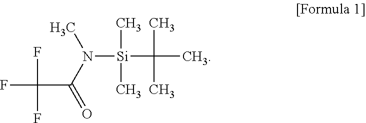

2. The electrolyte solution according to claim 1, wherein the electrolyte solution comprises the compound represented by Formula 1 in an amount of about 0.3 wt % to 1.2 wt % based on the total weight of the electrolyte solution.

3. The electrolyte solution according to claim 1, wherein the electrolyte salt comprises one or more selected from the group consisting of LiPF₆, LiBF₄, LiClO₄, LiCl, LiBr, LiI, LiB₁₀Cl₁₀, LiCF₃SO₃, LiCF₃CO₂, Li(CF₃SO₂)₃C, LiAsF₆, LiSbF₆, LiAlCl₄, LiCH₃SO₃, LiCF₃SO₃, LiN(SO₂C₂F₅)₂, Li(CF₃SO₂)₂N, LiC₄F₉SO₃, LiB(C₆H₅)₄, and Li(SO₂F)₂N (LiFSI).

4. The electrolyte solution according to claim 1, wherein a concentration of the electrolyte salt is about 0.5 M to 1.0 M.

5. The electrolyte solution according to claim 1, wherein the organic solvent comprises one or more from the group consisting of a carbonate-based solvent, an ester-based solvent, an ether-based solvent, and a ketone-based solvent.

6. A lithium secondary battery comprising:
a positive electrode;
a negative electrode;
a separator interposed between the positive electrode and the negative electrode; and
the electrolyte solution according to claim 1.

7. The lithium secondary battery according to claim 6, wherein the positive electrode comprises a positive-electrode active material including Ni, Co, and Mn, and
the negative electrode comprises at least one of a carbon (C)-based negative-electrode active material or a silicon (Si)-based negative-electrode active material.

8. A vehicle that comprises a battery of claim 6.
